(19) United States
(12) Patent Application Publication
(10) Pub. No.: US 2015/0027589 A1
(43) Pub. Date: Jan. 29, 2015

(54) Solder Paste

(71) Applicants: Senju Metal Industry Co., Ltd., Tokyo (JP); Denso Corporation, Aichi (JP)

(72) Inventors: Sakie Okada, Tochigi (JP); Motoki Koroki, Saitama (JP); Hiroaki Iseki, Saitama (JP); Taro Itoyama, Saitama (JP); Yoshitsugu Sakamoto, Aichi (JP); Hiromasa Hayashi, Aichi (JP)

(73) Assignees: Senju Metal Industry Co., Ltd., Tokyo (JP); Denso Corporation, Aichi (JP)

(21) Appl. No.: 14/368,760

(22) PCT Filed: Dec. 25, 2012
(86) PCT No.: PCT/JP2012/083444

§ 371 Date: Jun. 25, 2014

(30) Foreign Application Priority Data
Dec. 26, 2011 (JP) 2011-283761

(51) Int. Cl. B23K 35/36; B23K 35/02

(52) U.S. Cl. CPC B23K 35/3612; B23K 35/025
USPC 148/24

(57) ABSTRACT

A solder paste which solves any nozzle clogging that suddenly occurs in a case of being used in a discharging method and which also realizes residue-free because flux is decomposed by heating during soldering. In the solder paste produced by mixing solder powders with the flux, the flux is flux containing polyalkyl-methacrylate of not less than 1.0 mass % and less than 2.0 mass % as methacrylate polymer of an amount such that it prevents the solder powders from being sedimented at ordinary temperature and it is decomposed or evaporated in the process of heating during the soldering, and containing stearic acid amide of not less than 5.0 mass % and less than 15.0 mass %, as viscosity modifier, wherein viscosity is 50 through 150 Pa·s. It is preferable that the content of flux in the solder paste is not less than 11 mass % and less than 13 mass %.

### CROSS-REFERENCE TO RELATED APPLICATIONS

This is a national stage application filed under 35 U.S.C. 371 based on International Application No. PCT/JP2012/83444 filed Dec. 25, 2012, and claims priority under 35 U.S.C. 119 of Japanese Patent Application No. JP 2011-283761 filed Dec. 26, 2011.

### BACKGROUND OF THE INVENTION

### Technical Field

The present invention relates to solder paste produced by mixing flux with solder powders and it particularly relates to solder paste having an inhibitive effect of separation of the flux, which can be used in a discharging method and can realize residue-free of the flux.

### About Method of Supplying Solder Paste

In a surface mount technology (SMT) method in which chip parts are mounted on a substrate and the like, to which solder paste has been applied, and solder is melted in a reflow process to connect them electrically, a first step in a jointing step for assembling an electronic substrate and electronic devices starts from supplying to a joint part an appropriate quantity of the solder paste produced by mixing the solder powders with the flux.

In the methods of supplying the solder paste to the joint part, a method referred to as a screen-printing is common FIGS. 7A, 7B, 7C, 7D, 7E and 7F are illustrations showing an example of a screen-printing method. In the screen-printing method, as shown in FIG. 7A, a screen 104 made of a steel plate in which apertures 103 are formed with them being aligned with electrodes 102 on a substrate 101, and the substrate 101 are closely contacted to each other, as shown in FIG. 7B.

By sliding a squeegee 105 along a direction of an arrow F with it closely contacting the screen 104, as shown in FIG. 7D, while the solder paste S is put on the screen 104, as shown in FIG. 7C, the solder paste S is filled in the apertures 103. Next, by scraping the excessive solder paste S off using the squeegee 105, the solder paste S is filled in only the apertures 103 of the screen 104, as shown in FIG. 7E.

Thereafter, as shown in FIG. 7F, by separating the screen 104 and the substrate 101 from each other, the solder paste S filled in the apertures 103 of the screen 104 is transferred to a side of the substrate 101.

The method of supplying the solder paste by the screen-printing has been popularized as a method of allowing the solder paste to be accurately supplied at a lowest price when consecutively producing the substrates of same type. It also has maintained its position as the method of allowing the solder paste to be supplied to a soldered portion that has been extremely minimized and narrowed together with compactization of the substrate. In order to perform the screen-printing, however, an object needs to be flat.

In the methods of supplying the solder paste, the method called the discharging method is also used. FIG. 8 is an illustration showing an example of the discharging method. In the discharging method, the solder paste S fills a syringe 106 and the solder paste S is applied to electrodes 102 of a substrate 101 by discharging the solder paste S from a nozzle 107 attached with a tip of the syringe 106 using air pressure and so on.

The discharging method, which is different from the screen-printing method, has convenience such that an object to be supplied is not required to be flat and it is possible to supply the solder paste to even the object having any stereoscopic structure and also, to change supply quantity thereof without limit.

Therefore, the discharging method can be used in a step of applying the solder paste to a substrate on which components such as integrated circuit chip are mounted. FIGS. 9A, 9B, 9C, and 9D are motion illustrations showing an example of a process for producing an electronic device.

As shown in FIG. 9A, the solder paste S is applied from the nozzle 107 to a die-bonding part 111 of a substrate 110 using the discharging method as described with FIG. 8. On the die-bonding part 111, Ni plating layer, not shown in the figure, is formed. Then, a component 112 such as a power device is mounted on the die-bonding part 111 to which the solder paste S has been applied, as shown in FIG. 9B, by the die bonding. Ni plating layer, not shown in the figure, is also formed on a joint surface of the component 112.

The die bonding is referred to as a step of soldering the component 112 on the die-bonding part 111 of the substrate 110. In the die bonding, the component 112 is mounted on the die-bonding part 111 to which the solder paste S has been applied, and it is soldered in a reflow furnace.

The power device needs heat dissipation from a solder layer because it heats at an operation moment, and flux-less-soldering by preforms or wire solders has been previously common. Recently, the solder paste can be used because of productivity and costs, and in a case of using the solder paste, the solder paste is supplied using the discharging method.

As shown in FIG. 9C, the component 112 soldered on the die-bonding part 111 is configured so that a bonding pad 113 of the component 112 and a lead 114 of the substrate 110 are connected with each other by wire bonding.

The wire bonding is used when the component 112 and an internal circuit or an external terminal are connected with each other. In the wire bonding, wire 115 made of Al or Au wire and so on is connected thereto by vibration and pressure bonding with ultrasonic waves.

When connecting the component 112 and the lead 114 by the wire bonding, as shown in FIG. 9D, the component 112 and the lead 114 are molded by resin. The molding has a purpose of mechanical reliability, electrical reliability and protection on soldered part and circuit, by which the component 112 and the lead 114 are sealed by epoxy resin 116.

### Flux for Solder Paste

The basic characteristic of flux for soldering requires having capacity such as removal of metal oxide, prevention of re-oxidation in melting time of the solder and reduction in surface tension of the solder. When such flux is used in the solder paste, the flux has to have an additional property in which solder powders having large specific gravity and the flux are blended and dispersed and then, these solder powders are inhibited from being sedimented by gravity. This is referred to as an inhibitive effect of separation of the flux.

If the inhibitive effect of separation of the flux is weak, the flux floats up because the solder powders dispersed into the flux settle out by its own weight. When the flux separates according to the sedimentation of the solder powders, any concentration difference of the flux occurs in the solder paste so that it cannot be supplied stably. Even if the separation of flux occurs, however, it is possible to restore such a separation state of the flux to its original state by stirring the solder paste.

In case of the screen-printing method as shown in FIGS. 7A through 7F, a phenomenon of so-called “rolling” occurs on the screen 104 when the squeeze 105 slides with it closely contacting the screen 104 while the solder paste S is put on the screen 104 during a supply of the solder paste S as shown in FIGS. 7C through 7E. So, the separation of the flux does not occur so that it is supplied with it being stirred.

However, in a case of the solder paste S that fills the syringe 106 like the discharging method shown in FIG. 8, it is impossible to stir the solder paste S if the separation of flux occurs. Further, even when stirring the solder paste S in the syringe 106, this causes the air to be incorporated into the solder paste S during the stirring thereof. This results in that an air shot occurs during the discharging thereof.

Therefore, the flux used in the solder paste used in the discharging method must be the flux having a high inhibitive effect of separation of the flux. Further, the discharging method forces to be formed a system in which the syringe filled with the solder paste is pressurized and any pressure difference thereof causes the solder paste to be fluidized, so that unless the flux and the solder powders have the same fluidized rate while the solder paste is fluidized, a discharged quantity thereof is unstable.

### About Residue of Flux

Constituents of the flux used in the solder paste include some constituents, which cannot be decomposed and evaporated by heating during soldering, so that they remain after soldering around the soldered portion as the residue of the flux. If the residue of the flux results in corrosion activity, it gradually corrodes the soldered portions, so that short-circuits by migration and/or falling of the soldered portion by the corrosion occur.

Accordingly, although it is desirable to clean the residue of flux for prevention of corrosion, it has often arisen that in a general case of soldering the electronic substrate, by taking any costs for washing into consideration, material of the flux having weak corrosiveness is selected after reliability of the residue of flux has been checked and then, the solder joint process ends without removing any residue.

However, in an electronic device, particularly the device which has the die bonding as shown in FIG. 9B, as described above, the residue of flux exerts any bad influence upon a character of the wire bonding and a character of the molding in the post-process. It also exerts any influence upon insulation reliability of a circuit. Furthermore, in the wire bonding as shown FIG. 9C, surface contamination of the connected part exerts any influence upon joint performance thereof.

Therefore, the wire bonding is impossible on the pad covered with the residue of flux when the soldering ends without removing the residue of flux. In particular, when there is a bonding pad near the die bonding part having a large soldering area, the residue of flux is ejected from the die bonding part and flows to the bonding pad, so the wire bonding cannot be completely done.

Additionally, if there are steps of applying a moisture-proof coating to the soldered part, and of increasing strength of the solder portion by underfill, and there is a step of molding by resin as shown in FIG. 9D, the residue of flux and any of moisture-proof coating agent, underfill or molded epoxy resin are mutually melted at their contact interfaces, so that some parts inhibiting the moisture proof coating agent, underfill or hardening of the resin may occur. Further, when there is the residue of flux, this causes an adhesion between the resin and a lead flame or the soldered component to be deteriorated.

Thus, in the process of producing an electronic device in which there is steps of soldering by the die bonding, and, as the following steps, of wire bonding, molding and the like, it is necessary to clean the residue of flux. In this case, quality of cleaning the residue of flux is required.

Therefore, flux having a specification such that the components of the flux evaporate/sublime during soldering and the residue of flux is getting closer and closer to zero after soldering has become desired. Solder paste mixing the flux having components exerting such a property has been proposed (For example, see Patent Document 1).

### DOCUMENT FOR PRIOR ART

### Patent Document

Patent Document 1: Japanese Patent Application Publication No.2004-25305

### SUMMARY OF THE INVENTION

### Problems to be Solved by the Invention

Many kinds of solder paste in which the residue of flux does not remain after soldering have been proposed but they all are limited to only those supplied using the screen printing. This is because their development is in focus on a purpose of mass-production of electronic substrates or parts of a fixed specification.

On the other hand, when an object to which the solder paste is supplied is not a plane but has a solid geometry structure, it is impossible to supply the solder paste using the screen printing and it is necessary to adopt the discharging method in order to supply the solder paste to such an object.

However, higher fatty acid amide that is added to the flux as thixotropic agent in Patent Document 1 is effective in an improving property of fluidity as viscosity modifier and it has such an effect that it is decomposed into no residue during heating time. It, however, has a poor effect as antisettling agent of the solder powders.

Accordingly, if the solder paste to be used in the screen printing as described in Patent Document 1 is used in the discharging method and is discharged from a syringe that it has filled, a discharged amount thereof becomes unstable when it is continuously discharged because the inhibitive effect of separation of the flux is weak, and the discharge stops suddenly because the solder powders get clogged inside the nozzle.

The present invention solves such unstableness of the discharge and the suddenly occurred clogging in the nozzle and has an object to provide solder paste that realizes residue-free by decomposing the flux by heating during the soldering.

### Means for Solving the Problems

The materials used for the flux for solder paste, which have a property of becoming residue-free after heating by reflow soldering, were selected from materials, which evaporate/sublime with heating. Inventors actually prepared the flux to form the solder paste and filled discharging equipment with it. They monitored the discharged amount thereof by putting pressure on the equipment intermittently. Furthermore, they searched the combination of the flux which does not clog the nozzle during discharging and discharged quantity of which is stable.

Accordingly, the inventors have found out solder paste that can realize any stable discharge by using both of the effects of antisettling of the solder powders by polyalkyl-methacrylate and increasing the fluidity of the solder paste by stearic acid amide when pressurizing the syringe. This solder paste adds a property of the residue-free flux after the soldering to the solder paste, which is suitable for the discharging method in which the supply of the solder paste can be freely controlled without any screen.

This invention relates to solder paste which is produced by mixing solder powders with flux, the flux containing polyalkyl-methacrylate of not less than 1.0 mass % and less than 2.0 mass % as methacrylate polymer of an amount such that it prevents the solder powders from being sedimented at ordinary temperature and it is decomposed or evaporated in the process of heating during soldering, and stearic acid amide of not less than 5.0 mass % and less than 15.0 mass %, as viscosity modifier, wherein viscosity is 50 through 150 Pa·s.

It is preferable that the solder paste contains the flux of not less than 11 mass % and less than 13 mass %.

### Effects of the Invention

The solder paste according to this invention enables residue-free to be realized because the flux is decomposed or evaporated by heating by reflow soldering to remain no residue of flux. In addition, it is possible to make the discharged amount thereof stable when it is supplied and discharged using the discharging method, by maintaining the property such that the flux becomes no residue after reflow, preventing the solder powders from being sedimented, and keeping the desired viscosity. This allows any applying position and any applied amount of the solder paste to be changed, so that it is possible to provide a production process inexpensively in a moment of assembling electronic substrates and electronic parts having various specifications.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

FIG. 1 is an illustration showing composition examples of the solder paste according to this embodiment.

FIG. 2 is a graph showing a transition about content of flux and discharged quantity of the solder paste.

FIG. 3 is a graph showing a transition about composition of the flux and the discharged quantity of the solder paste.

FIG. 4 is a graph showing a relationship among the content of the flux, particle sizes of solder powders, and viscosity of the solder paste.

FIG. 5 is a graph showing a relationship among the content of the flux, the particle sizes of the solder powders, and discharged quantity of the solder paste.

FIG. 6 is a graph showing a relationship between the viscosity of the solder paste and the discharged quantity of solder paste.

FIG. 7A is an illustration showing an example of a screen-printing method.

FIG. 7B is an illustration showing the example of the screen-printing method.

FIG. 7C is an illustration showing the example of the screen-printing method.

FIG. 7D is an illustration showing the example of the screen-printing method.

FIG. 7E is an illustration showing the example of the screen-printing method.

FIG. 8 is an illustration showing an example of a discharging method.

FIG. 9A is a motion illustration showing an example of a manufacturing process of electronic device.

FIG. 9B is a motion illustration showing the example of the manufacturing process of electronic device.

FIG. 9C is a motion illustration showing the example of the manufacturing process of electronic device.

FIG. 9D is a motion illustration showing the example of the manufacturing process of electronic device.

### DETAILED DESCRIPTION OF PREFERRED EMBODIMENTS

Solder paste according to the embodiment is produced by mixing flux with solder powders. The flux included in the solder paste contains methacrylate polymer as thixotropic agent for preventing solder powders from being sedimented. As the methacrylate polymer, polyalkyl-methacrylate having alkyl groups is preferable. Additionally, as viscosity modifier, it contains stearic acid amide. Alloy composition of the solder powders to be mixed are not limited in particular.

The solder paste mixing the flux to which polyalkyl-methacrylate is added with the solder powders prevents the solder powders from being sedimented in ordinary temperature such as room temperature. In a case of using the solder paste in the discharging method, even if the solder paste fills a syringe and it cannot be stirred, the separation of the flux and the solder powders is inhibited.

Polyalkyl-methacrylate evaporates in the process of the heating by soldering and after soldering, polyalkyl-methacrylate does not substantially remain and realizes residue-free. A period of necessary time when it takes for polyalkyl-methacrylate to evaporate in the heating process of soldering differs according to the content of polyalkyl-methacrylate added into the flux.

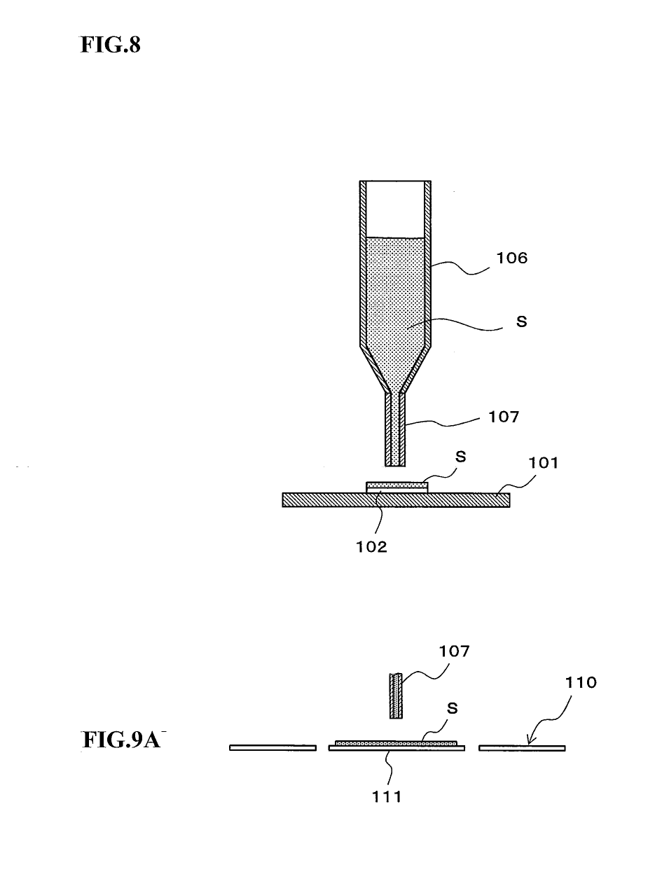

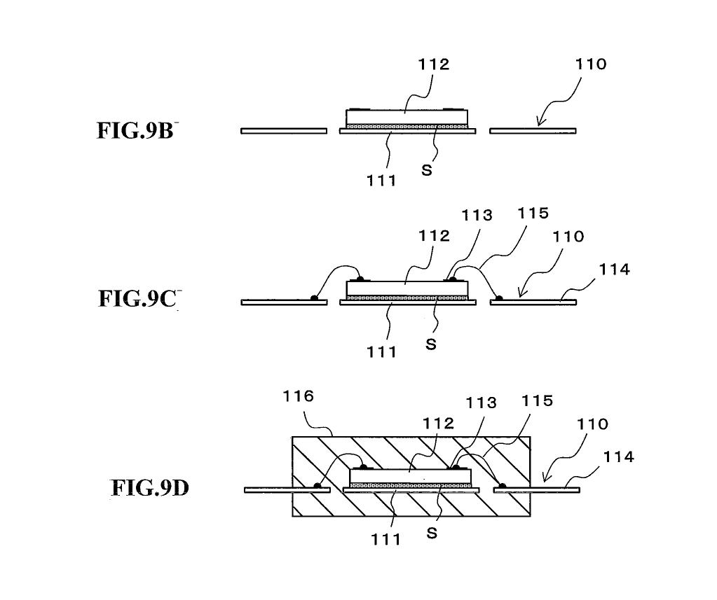

Moreover, when using the solder paste in the discharging method as shown in FIG. 8, the discharged quantity of the solder paste receives any influence of the inhibition of separation of the solder powders and the flux and the viscosity of the solder paste. Then, the viscosity of the solder paste changes by the content of stearic acid amide added to the flux. The viscosity of the solder paste also changes by the content of the flux in the solder paste, and particle sizes of the solder powders.

The discharged quantity of the solder paste tends to increase at a case where the viscosity of the solder paste is lower as compared with a case where viscosity of the solder paste is higher. The more content of the flux in the solder paste increases, the less viscosity of the solder paste becomes. The time until being no residue becomes longer, however, if the content of the flux increases. Additionally, it is impossible to inhibit the separation of the solder powders and the flux if the viscosity of the solder paste is too low.

Moreover, it is already known that in a case of soldering using the solder paste, when the content of the flux is small, the slump during heating is restrained and the voids remained inside the jointed portion after soldering become fewer. Accordingly, it is necessary to find out any composition of the flux, which can ensure the stability of discharge in a case of using the solder paste in the discharging method within a range in which content of the flux is as small as possible.

FIG. 1 is an illustration showing composition examples of the solder paste according to this embodiment. FIG. 1 illustrates content of polyalkyl-methacrylate, content of stearic acid amide and viscosity of the solder paste at combinations of the specified content of polyalkyl-methacrylate and the specified content of stearic acid amide.

In the solder paste according to the embodiment, considering the necessary time for the evaporation of polyalkyl-methacrylate in the process of the heating by soldering, it is preferable that the content of polyalkyl-methacrylate in the flux is not less than 1.0% and less than 2.0% in order to obtain inhibitive effect of separation of the solder powders and the flux by addition of polyalkyl-methacrylate.

In addition, it is preferable that the content of the stearic acid amide in the flux is not less than 5.0% and less than 15.0% in order to increase fluidity of the solder paste.

Furthermore, considering the inhibition of the separation of the flux and the solder powders and the secure of the discharged quantity of the solder paste in the case of using it by the discharging method, it is preferable that the viscosity of the solder paste is not less than 50 Pa·s and less than 150 Pa·s.

Then, when the content of polyalkyl-methacrylate in the flux is not less than 1.0% and less than 2.0% and the content of stearic acid amide therein is not less than 5.0% and less than 15.0%, the content of polyalkyl-methacrylate and the content of stearic acid amide are selected so that viscosity of the solder paste becomes not less than 50 Pa·s and less than150 Pa·s. The region illustrated by solid lines as shown in FIG. 1 shows an optimum region that satisfies the conditions in which it is capable of discharging when using it in the discharging method and realizing residue-free by heating during the soldering.

Solder paste according to the embodiment ensures desired discharged quantity of the solder paste by preventing it from clogging in the nozzle in a case of being used in the discharging method. Solder paste according to the embodiment also realizes residue-free by using the flux, which has components evaporating in the process of the heating during the soldering.

Here, when the flux evaporates/sublimes in the process of the heating during the soldering, any capacities that the flux has such as decomposition and removal of metal oxide, prevention of re-oxidation in dissolution time of solder and reduction in surface tension of the solder lose in the dissolution time of solder. Therefore, the solderability by the flux becomes insufficient. For this reason, in the process of the heating during the soldering, a condition inside reflow furnace is non-oxidation atmosphere or weakly reducing atmosphere which is not the explosion range (5% H2 or less).

### EXECUTED EXAMPLES

### Relationship Between Content of Flux and Discharged Quantity of Solder Paste

Species of the flux of composition 1 through the composition 3 having compositions shown in the following Table 1 were mixed. Nine types A through I of the solder paste shown in Table 2 were prepared by mixing each of the species of flux of the composition 1 through the composition 3 with the solder powders (Sn-3Ag-0.5Cu, Particle sizes: 25 through 36 μm) so that the content of each of the species of flux is 10%, 11% or 12%. Then, in a case of using the solder paste in the discharging method, they were compared on the relationship between the content of the flux and the discharged quantity of solder paste.

TABLE 1

| | Composition 1 | Composition 2 | Composition 3 |
|---|---|---|---|
| Volatile Thickener | 30% | 30% | 30% |
| Trimethylolpropane | 30% | 30% | 30% |
| Stearic Acid Amide | 5% | 5% | 5% |
| Polyalkyl-methacrylate | 0% | 1% | 2% |
| 1,2,6-hexanetriol | 10% | 10% | 10% |
| Octanediol | 24.5% | 24% | 23% |

TABLE 2

| | Composition 1 | Composition 2 | Composition 3 |
|---|---|---|---|
| Content of Flux, 10% | Solder Paste A | Solder Paste B | Solder Paste C |
| Content of Flux, 11% | Solder Paste D | Solder Paste E | Solder Paste F |
| Content of Flux, 12% | Solder Paste G | Solder Paste H | Solder Paste I |

Various species of the solder paste described above fill the syringe. They were continuously discharged under the conditions showing below and the transition of the discharged quantity was monitored.
Nozzle: Internal diameter of 0.72 mm φ
Discharge pressure: 0.2 MPa·s
Discharge time: 0.5 sec
Interval: 0.5 sec

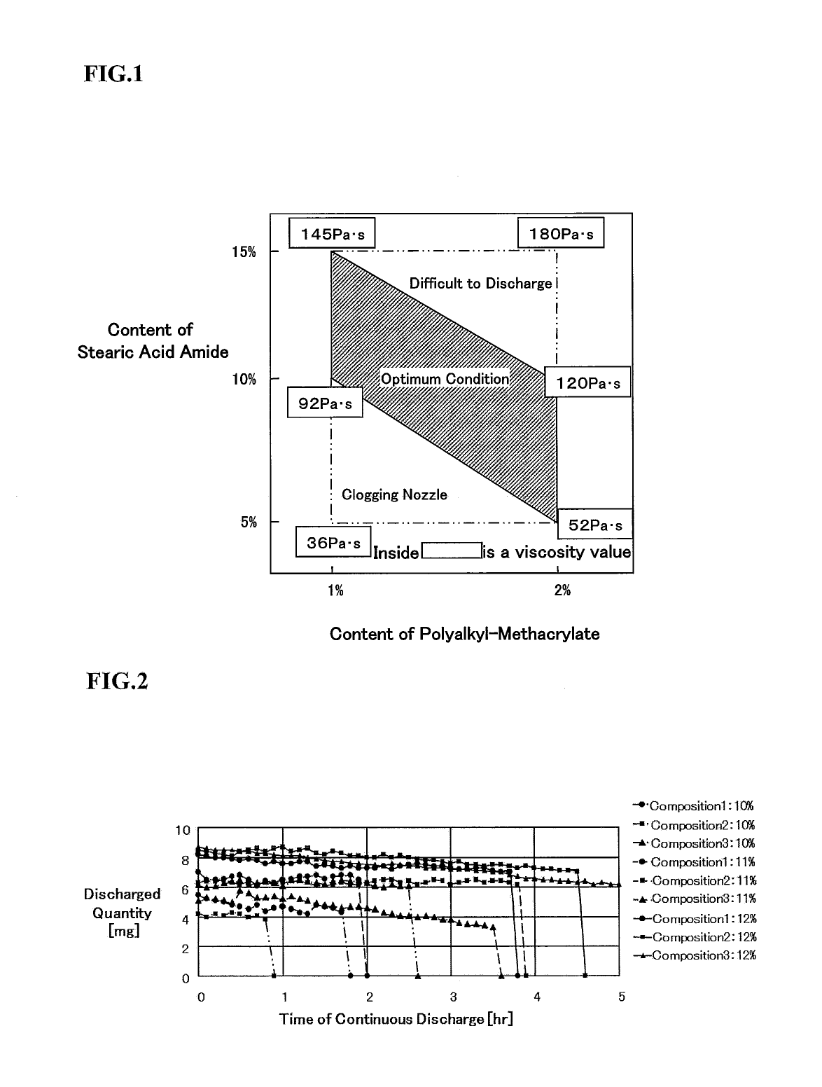

FIG. 2 is a graph showing the transition about content of the flux and discharged quantity of the solder paste. As shown in the graph of FIG. 2, in the solder paste including each of the species of flux having the compositions of Table 1, the nozzle was clogged within five hours from a start of the discharge except for the solder paste I in which content of the flux having the composition 3 was 12% and then, it could not be discharged.

As shown in the graph of FIG. 2, when the content of the flux in the solder paste is increased, the time until nozzle is clogged tends to be extended. In addition, in the compositions of the flux, the time until nozzle is clogged tends to be more extended in the composition 2 and the composition 3, which include polyalkyl-methacrylate than that in the composition 1, which does not include polyalkyl-methacrylate.

The solder paste A through the solder paste C in which the content of flux is 10% are not much influenced by the component of flux and in any of the species of the flux having the composition 1 through the composition 3, the time until the nozzle is clogged tends to be shortened.

Because of this, it has been understood that the content of flux in the solder paste has to be not less than 11% in order to discharge the solder paste stably from the nozzle.

### Relationship Between Component of Flux and Discharged Quantity of Solder Paste

Species of the flux of composition 4 through 7 having the compositions as shown in the following Table 3 were mixed. Four types J through M of the solder paste shown in Table 4 were prepared by mixing each of the species of flux of the composition 4 through the composition 7 with the solder powders (Sn-3Ag-0.5Cu, Particle sizes: 25 through 36 μm) so that the content of each of the species of flux is 11%, based on the above-mentioned studied result. Then, the discharging examination was carried out under the above-mentioned condition and in the case of using the solder paste in the discharging method, they are compared on the relationship between the components of flux and the discharged quantity of solder paste.

TABLE 3

| | Composition | Composition | Composition | Com- |
|---|---|---|---|---|
| | 4 | 5 | 6 | position 7 |
| Volatile Thickener | 20% | 20% | 20% | 30% |
| Trimethylolpropane | 30% | 30% | 30% | 30% |
| Stearic Acid Amide | 10% | 10% | 15% | 15% |
| Polyalkyl- | 1% | 2% | 1% | 2% |
| methacrylate | | | | |
| 1,2,6-hexanetriol | 10% | 10% | 10% | 10% |
| Octanediol | 29% | 28% | 24% | 23% |

TABLE 4

| | Composition | Composition | Composition | Composition |
|---|---|---|---|---|
| | 4 | 5 | 6 | 7 |
| Content of | Solder Paste J | Solder Paste K | Solder Paste L | Solder Paste M |
| Flux, 11% | | | | |

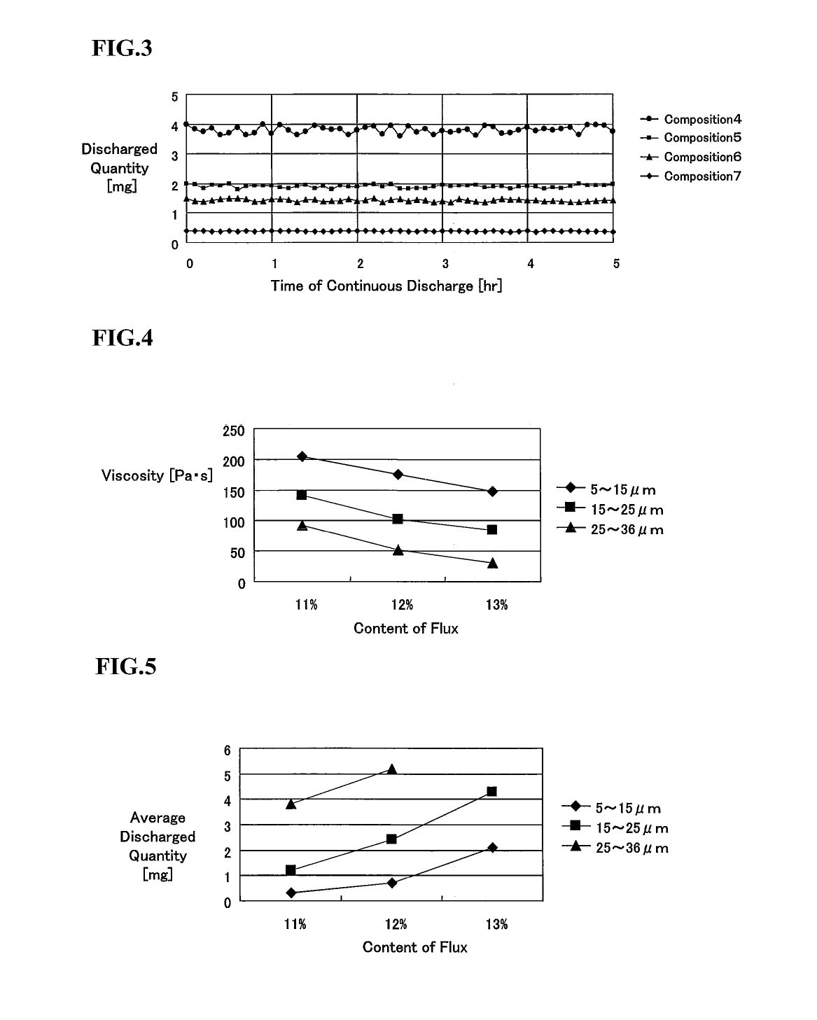

FIG. 3 is a graph showing a transition about compositions of the flux and the discharged quantity of the solder paste. As shown in the FIG. 3, there was no solder paste, which clogged the nozzle during the predetermined time of continuous discharge, five hours in this example. It is conceivable that this is based on an effect as a lubricant of stearic acid amide in addition to the inhibitive effect of separation of the flux and the solder paste by polyalkyl-methacrylate.

On the other hand, difference in the average discharged quantity significantly arose from the compositions of the flux. It is conceivable that this is because the viscosity of the solder paste rapidly rises if large quantity of the stearic acid amide is added into the flux, but the viscosity descends if small quantity of the stearic acid amide is added thereto.

By taking these points into consideration, it has been found out that species of the dischargeable solder paste are species of the solder paste J through the solder paste L which use the species of flux having the composition 4 through the composition 6, but the solder paste M using the flux of the composition 7 is unsuitable to discharge because the discharged quantity thereof is too small.

### Relationship among Content of the Flux, Particle Sizes of the Solder Powders and Discharged Quantity of Solder Paste

Based on the above results, nine types N through V of the solder paste were prepared in which the flux of the composition 4 having content of the polyalkyl-methacrylate of 1% and content of the stearic acid amide of 10%, which was under the condition about the largest discharged quantity of the solder paste, had content shown in the following Table 5 and the particle sizes of solder powders (Sn-3Ag-0.5Cu) were those shown in the following Table 5. Then, the discharging examination was carried out under the above-mentioned condition and in the case of using the solder paste in the discharging method, they are compared on the relationship among the content of the flux, the particle sizes of solder powders, and the discharged quantity of the solder paste.

TABLE 5

| | Solder Particle | Solder Particle | Solder Particle |
|---|---|---|---|
| | Sizes 5-15 μm | Sizes 15-25 μm | Sizes 25-36 μm |
| Content of Flux, 11% | Solder Paste N | Solder Paste O | Solder Paste P |
| Content of Flux, 12% | Solder Paste Q | Solder Paste R | Solder Paste S |
| Content of Flux, 13% | Solder Paste T | Solder Paste U | Solder Paste V |

FIG. 4 is a graph showing the relationship among the content of the flux, the particle sizes of solder powders, and the viscosity of the solder paste. As shown in FIG. 4, if the content of flux in the solder paste increases, the viscosity of the solder paste indicates the tendency of decreasing. Moreover, if the particle size of the solder powders becomes small, the viscosity of solder paste indicates the tendency of increasing.

FIG. 5 is a graph showing the relationship among the content of the flux, the particle sizes of the solder powders, and the discharged quantity of the solder paste. As shown in FIG. 5, if the content of flux increases, the discharged quantity of the solder paste indicates the tendency of increasing. Moreover, if the particle size of the solder powders becomes large, the discharged quantity of solder paste indicates the tendency of increasing. Owing to this, together with the result shown in FIG. 4, if the viscosity of solder paste decreases, the discharged quantity of the solder paste tends to increase.

It is to be said that in FIG. 5, the data of solder paste V in which the particle sizes of solder powders are 25 through 36 μm and the content of flux is 13% is missing. This is because the viscosity of the solder paste is too low and the flux in the solder paste separates before the discharging examination is carried out, and the discharging examination becomes impossible.

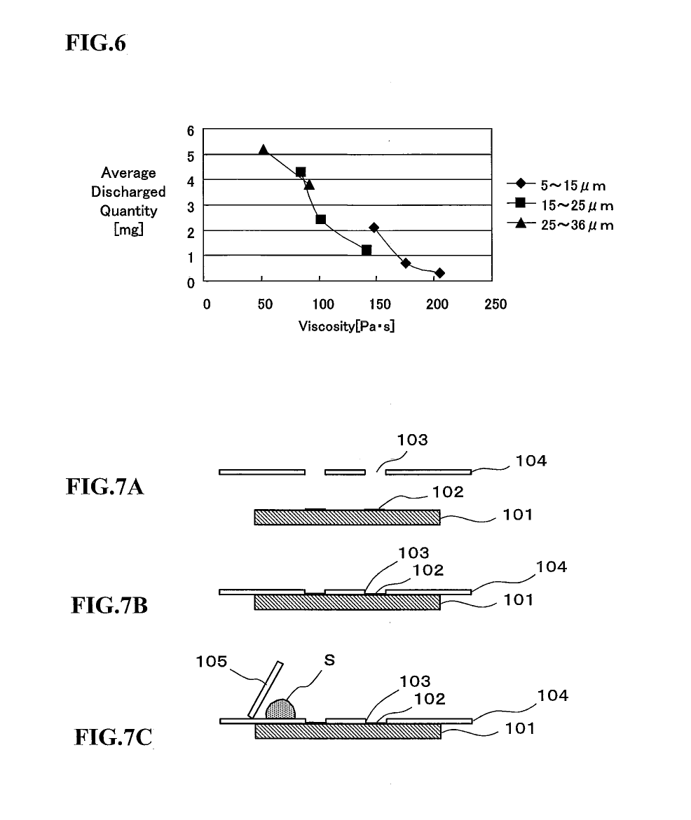

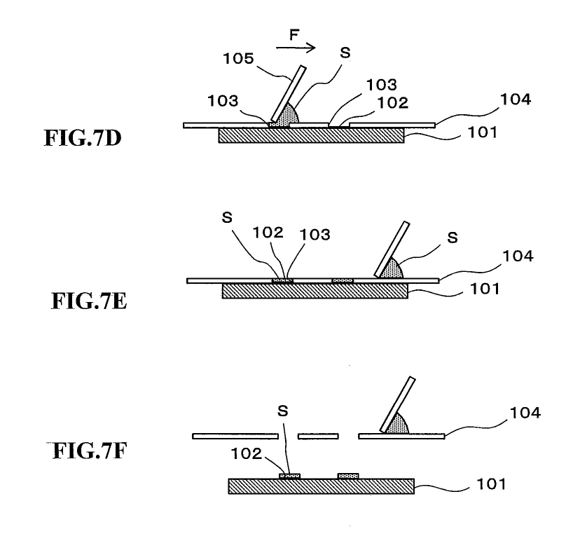

FIG. 6 is a graph showing the relationship between the viscosity of solder paste and the average discharged quantity of solder paste. As shown in FIG. 6, if the viscosity of solder paste becomes 150 Pa·s or more, the average discharged quantity thereof becomes 1 mg or less, which is unsuitable for the discharge because the discharged quantity thereof is too small. On the other hand, if the viscosity of the solder paste becomes less than 50 Pa·s, the problem occurs such as a nozzle clogging from the above-mentioned separation phenomenon of the flux, which is unsuitable for the discharge as well.

According to the above results, it has been understood that the optimum viscosity range of the solder paste is 50 through 150 Pa·s. In addition, it has been understood that in the flux of the composition having content of polyalkyl-methacrylate of not less than 1.0% and less than 2.0% and content of the stearic acid amide of not less than 5.0% and less than 15.0%, by selecting the content of the polyalkyl-methacrylate and the content of the stearic acid amide so that the viscosity of the solder paste becomes not less than 50 Pa·s and less than 150 Pa·s, the range showed by the solid lines in FIG. 1 is the optimum range which satisfies the condition such that it is possible to discharge the solder paste when using it in the discharging method and the residue-free is realized by the heating during the soldering.

### INDUSTRIAL APPLICABILITY

The solder paste according to the invention is applicable to a supply in the discharging method because it is possible to realize the prevention of the sedimentation of solder powders and the residue-free of the flux after the soldering.

1-2. (canceled)

3. Solder paste which is produced by mixing solder powders with flux, characterized in that the flux includes only volatile thickener, trimethylolpropane, 1,2,6-hexanetriol, octanediol, polyalkyl-methacrylate, and stearic acid amide, and wherein the flux contains the polyalkyl-methacrylate in a quantity of not less than 1.0 mass % and less than 2.0 mass % and stearic acid amide in a quantity of not less than 5.0 mass % and less than 15.0 mass %, and wherein the viscosity is in the range of 50 through 150 Pa·s.

4. The solder paste according to claim 1 characterized in that the solder paste contains the flux in a quantity of not less than 11 mass % and less than 13 mass %.
